(19) United States
(12) Patent Application Publication
(10) Pub. No.: US 2013/0019433 A1
(43) Pub. Date: Jan. 24, 2013

(54) DEVICE FOR SPACING AN OPENING ELEMENT APART FROM A STATIONARY ELEMENT IN PARTICULAR OF A MOTOR VEHICLE

(71) Applicant: Stéphane Perche, Saint Bardoux (FR)

(72) Inventor: Stéphane Perche, Saint Bardoux (FR)

(73) Assignee: EXSTO, Romans Sur Isere (FR)

(21) Appl. No.: 13/635,570

(22) PCT Filed: Mar. 17, 2011
(86) PCT No.: PCT/FR2011/050536

§ 371 Date: Sep. 28, 2012

(30) Foreign Application Priority Data
Mar. 17, 2010 (FR) 10/51889

(51) Int. Cl. E05C 17/20

(52) U.S. Cl. 16/82

(57) ABSTRACT

A device for spacing an openable element apart from a stationary element which includes an integral attachment sub-assembly intended for being attached to the openable element or to the stationary element and which includes at least one frame including at least one first side edge and at least one second side edge, a first main fin and a second main fin, said first main fin and second main fin each extending between the first side edge and the second side edge such as to define a sliding section therebetween, said first main fin and second main fin being provided with a means to resist movement intended for engaging with a complementary means for resisting movement of a complementary attachment sub-assembly intended for being attached to the stationary element or the openable element.

The present invention relates to a device for spacing an opening element apart from a stationary element, and more particularly to a device for spacing a door apart from the frame of a body of a motor vehicle.

A spacing-apart device is installed between each door and the frame of a motor vehicle in order to be able to maintain the door in a stabilized open position. Such a spacing-apart device is generally made in metal and requires a certain amount thereof, which is inevitably passed on to the manufacturing costs of said vehicle, and this all the more since the price of metals is high.

Moreover, on production lines, it has been known for a very long time how to install a spacing-apart device, notably between each door and the frame of the motor vehicle, before the different steps for coating the opening element and/or the whole body of said vehicle, and then disassemble it once these coating steps have been carried out. This spacing-apart device is mounted instead and in place of the definitive metal spacing-apart device and thus allows the door of the vehicle to be maintained in a certain position so that the inner areas of said vehicle may be painted.

Such a spacing-apart device is described as “temporary”, and is generally made in plastic or in lightweight steel.

It should be noted that when the spacing-apart device is made in plastic, the latter further has the advantages, as compared with a spacing-apart device in metal or in lightweight steel, of generating less significant noise and allowing reduction of the paint grains.

As an example, such a spacing-apart device for temporary use, notably made in plastic is described in patent application FR 2 920 808 A1. More specifically, the spacing-apart device comprises an attachment sub-assembly on the opening element or the stationary element, and on the other hand a complementary attachment sub-assembly on the stationary element or the opening element, the complementary attachment sub-assembly being extended with a guide comprising a contact area split up into a first track and into a second track extending on either side of means to resist movement, the attachment sub-assembly being equipped with at least one follower element designed so as to move along the contact area so that the opening element may alternately be placed in an open position or in a closed position. Further, the means to resist movement are formed by a spike protruding from the guide and forcing the person proceeding with the opening of the opening element to exert additional forces in order to force the follower element to cross this obstacle in order to come into contact with the second track. The opening element is then found stabilized in the open position. Therefore, it is necessary to exert forces in the opposite direction in order to force the follower element to move beyond the spike with view to coming back into contact with the first track in order to close the opening element.

However, one of the major drawbacks of these so-called “temporary” spacing-apart devices which are used with view to carrying out steps for coating the opening element and/or the whole body on production lines, lies in the fact that when these spacing-apart devices are made in lightweight steel, this is also inevitably passed on to the manufacturing costs of said vehicle, and this all the more since the price of lightweight steel is high. Now, one is forced to try to reduce the manufacturing costs of vehicles, notably by trying to minimize the costs of “temporary” parts required for carrying out certain vehicle manufacturing steps.

Also, when these so-called “temporary” spacing-apart devices are made in plastic, of course a less expensive material than steel or metal, they may, depending on their design, prove to be insufficiently resistant for supporting the stresses to which they are subject during successive opening and closing operations carried out by the operator during the aforementioned coating steps. Further, their costs may also prove to be expensive depending on the amount of plastic required for their manufacturing and on the complexity of the parts which make them up.

The present invention proposes to find a remedy to these major drawbacks of these spacing-apart devices by providing a spacing-apart device which not only may be manufactured while requiring a lesser amount of material and at low costs, but also may, because of its properly dimensioned configuration, be subject to very large stresses without however exceeding the elastic limits of said materials.

The invention relates to an attachment sub-assembly making up a spacing-apart device, and intended to be attached on an opening element or on a stationary element, said attachment sub-assembly comprising at least one frame which includes:
at least one first side edge and at least one second side edge,
at least one main fin and at least one second main fin, said first main fin and second main fin each extending between the first side edge and the second side edge so as to delimit between them a sliding section S, said first main fin and second main fin being equipped with means to resist movement intended to cooperate with complementary means to resist movement of a complementary attachment sub-assembly intended to be attached on the stationary element or the opening element.

Further, said attachment sub-assembly is characterized in that it is made in one piece, preferably in plastic material.

Within the scope of the present invention, by side edge should be understood both a side edge having a planar section and a side edge having a curved section. Thus, the general shape of the frame may come in different versions, and be substantially parallelepipedal or at least partly curved.

Advantageously, said first main fin and second main fin are substantially parallel.

Preferably, the means to resist movement are made as protruding abutment elements placed facing each other on the first and second main fin, respectively.

Preferentially, at least two secondary fins extend between the first side edge and the second side edge of the frame and are positioned respectively on either side of the sliding section S.

According to an embodiment, said secondary fins are respectively substantially parallel to the first main fin and to the second main fin.

Advantageously, the first main fin is connected to the secondary fin which is adjacent to it, through at least one first means acting as a structure reinforcement, and the second main fin is connected to the secondary fin which is adjacent to it, through at least one second means acting as a structure reinforcement.

Of course, if the attachment sub-assembly comprises several levels of fins on each side of the sliding section, generally, a structure reinforcement means will be positioned on either side of said sliding section, so as to respectively connect each first main fin to its corresponding secondary fins and each second main fin to its corresponding secondary fins, and this in order to reinforce the whole of the structure of the frame.

Preferably, the first and second means acting as a structure reinforcement are respectively positioned in the middle transverse plane of the first main fin and of the second main fin.

According to an embodiment, said first and second main fins and the secondary fins each have a substantially convex edge.

The invention relates to a complementary attachment sub-assembly making up a spacing-apart device, and intended to be attached on a stationary element or on an opening element, said complementary attachment sub-assembly being extended with a guide, said guide comprising complementary means to resist movement, intended to cooperate with the means to resist movement of an attachment sub-assembly as described above, said guide being made as a plate having a first face and a second face each equipped with a contact area split into a first track and into a second track extending on either side of the complementary means to resist movement.

Advantageously, the contact area of the first face and the contact area of the second face are respectively made in the form of a rail.

Preferably, the second track of each rail is closed.

The invention also relates to a device for spacing an opening element apart from a stationary element which comprises:
at least one attachment sub-assembly as described above,
at least one complementary attachment sub-assembly as described above.

More specifically, the invention relates to a device for spacing an opening element apart from a stationary element which is characterized in that it comprises:
at least one attachment sub-assembly as described above,
at least one complementary attachment sub-assembly making up a spacing-apart device, and intended to be attached on a stationary element or on an opening element, said complementary attachment sub-assembly being extended with a guide, said guide comprising complementary means to resist movement, intended to cooperate with the means to resist movement of an attachment sub-assembly as described above, said guide being made as a plate having a first face and a second face each equipped with a contact area split up into a first track and into a second track extending on either side of the complementary means to resist movement.

Advantageously, the contact area of the first face and the contact area of the second face are respectively made in the form of a rail. Preferably, the second track of each rail is closed.

Quite advantageously, the spacing-apart device is made in plastic material.

According to a first alternative embodiment of the invention, the spacing-apart device is made in plastic material, most particularly adapted to a simple application design. Thus, such a spacing-apart device may be installed temporarily with view to steps for applying different coatings on the opening element and/or on the whole body, and be then replaced with a definitive metal spacing-apart device.

According to a second alternative embodiment of the invention, the spacing-apart device is made in metal, advantageously according to an application design requiring lesser amounts of metals. Such a spacing-apart device may then be installed definitively.

The application of the invention will be better understood by means of the detailed description which is discussed below with reference to the appended drawing wherein:

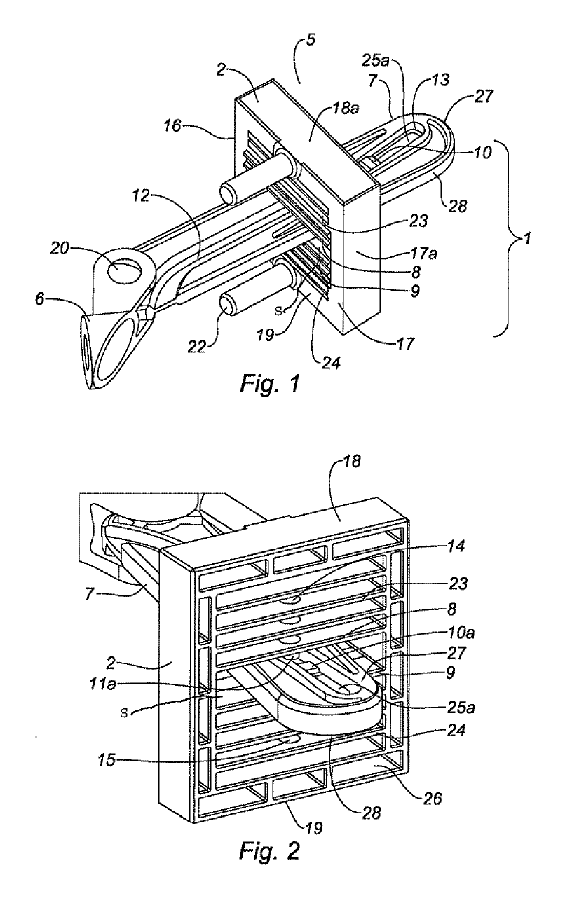

FIG. 1 is a perspective side view of a spacing-apart device according to the invention in the process of being opened;

FIG. 2 is a perspective rear view of a spacing-apart device according to the invention in the process of being opened;

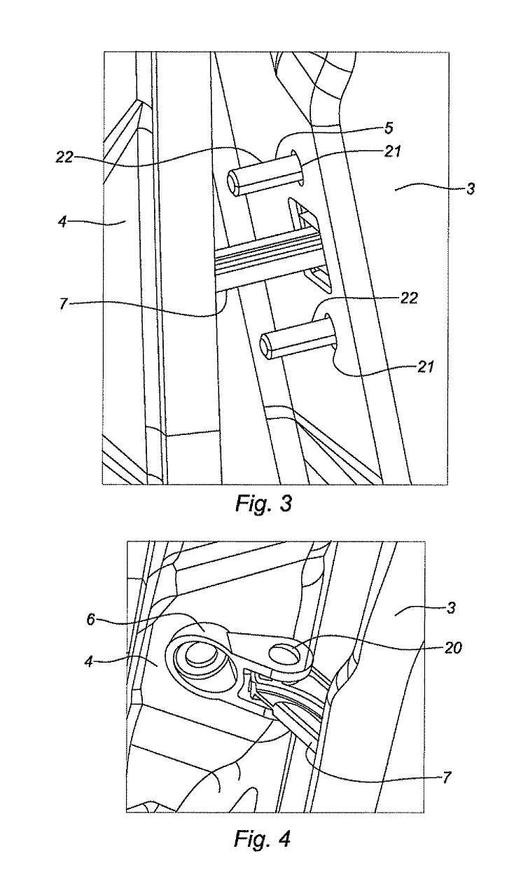

FIG. 3 is a perspective view showing the attachment of a spacing-apart device according to the invention at the door of a motor vehicle.

FIG. 4 is a perspective view showing the attachment of a spacing-apart device according to the invention at the frame of a body of a motor vehicle.

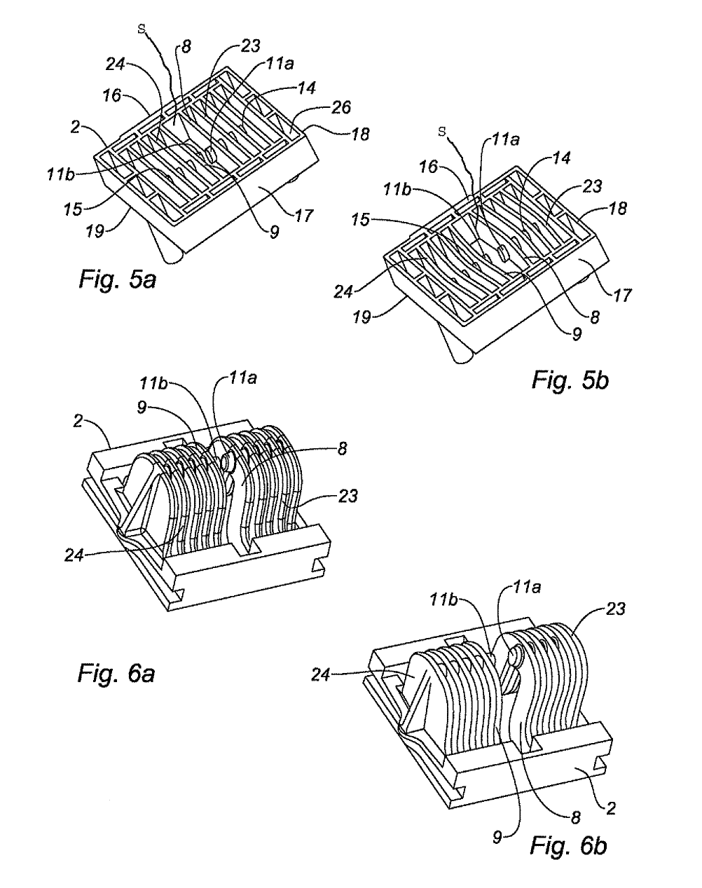

FIG. 5a is a perspective view of an attachment sub-assembly according to the invention.

FIG. 5b is a perspective view of the attachment sub-assembly illustrated in FIG. 5a when the fins of the frame are subject to stresses exerted by the means to resist movement of a complementary attachment sub-assembly according to the invention.

FIG. 6a is a perspective view of another embodiment of an attachment sub-assembly according to the invention wherein the fins each have a substantially convex edge.

FIG. 6b is a perspective view of the embodiment of the attachment sub-assembly illustrated in FIG. 6a when the fins of the frame are subject to the stresses exerted by the means to resist movement of a complementary attachment sub-assembly according to the invention.

A spacing-apart device 1 according to the invention as illustrated in FIGS. 1 and 2, preferably made in a plastic material, comprises an attachment sub-assembly 5, a complementary attachment sub-assembly 6, the complementary attachment sub-assembly 6 being extended with a guide 7. As illustrated in FIG. 1, the complementary attachment sub-assembly 6 is connected to the guide 7 by means of a pivot connection comprising an axis 20.

The guide 7 is made as a plate with a first face 27 and a second face 28.

The first face 27 comprises a contact area, split up into a first track 12 and into a second track 13 on either side of the complementary means 10 to resist movement, which is made in the form of a rail 25a.

The second face 28 comprises a contact area split up into a first track 12 and into a second track 13 on either side of the complementary means 10 to resist movement, which is made in the form of a rail 25b not visible in FIGS. 1 and 2.

The complementary means 10 to resist movement are made in the form of protruding abutment elements, in this case lugs 10a, 10b. The lugs 10a, 10b are respectively positioned on the first face 27 and the second face 28. The lug 10b is not visible in FIGS. 1 and 2. Other complementary means 10 to resist movement may be contemplated and are within the reach of one skilled in the art.

The attachment sub-assembly 5 comprises a frame 2 with a parallelepipdal general shape which comprises a first side edge 16, a second side edge 17, a third side edge 18 and a fourth side edge 19.

As shown in FIG. 2, the frame 2 includes a first side edge 16 and a second side edge 17, as well as, a first main fin 8 and three secondary fins 23 on the one hand, and a second main fin 9 and three secondary fins 24 on the other hand.

The whole of the fins 8, 9, 23, 24 extend between the first side edge 16 and the second side edge 17 and are comprised in the volume of the frame 2, as shown by FIGS. 1, 2 and 5a and 5b.

In another embodiment, as illustrated in FIGS. 6a and 6b, the fins 8, 9, 23, 24 each have a substantially convex edge.

Thus, the first main fin 8 and second main fin 9 each extend between the first side edge 16 and the second side edge 17 so as to determine a sliding section S, into which is inserted the guide 7 as this is illustrated in FIGS. 1 and 2.

The first main fin 8 comprises a protruding abutment element 11a, in this case a lug, facing a protruding abutment element 11b, in this case a lug, of the second main fin 9.

First means acting as a structure reinforcement 14 connect the first main fin 8 to its three corresponding secondary fins 23 between each other.

Second means acting as a structure reinforcement 15 connect the second main fin 9 to its free corresponding secondary fins 24 between each other.

These means acting as a structure reinforcement 14, 15 thus allow reinforcement of the structure of the frame 2.

The frame 2 further has two attachment screws 22 which are designed so as to be inserted into two orifices 21 made in an opening element 3, in this case the door of a motor vehicle, and this as illustrated in FIG. 3. The two attachment screws 22 are attached with two nuts not shown in this FIG. 3. Of course, other embodiments of this attachment may be contemplated and are within the reach of one skilled in the art.

This attachment sub-assembly 5, consisting of the frame 2 and of attachment screws 22, is made as a single piece in plastic material. Indeed it is very advantageous if parts of the spacing-apart device 1, and in particular the attachment sub-assembly 5, are parts made as a single piece, preferably in plastic material, since they are more easily shapeable and require a raw material at not very high prices, without this being a limitation to the present invention. Further, the use of plastic material, in particular for making the frame 2, allows it to be subject to significant forces without it exceeding the elastic limits of these materials.

More specifically, each side edge 16, 17, 18, 19 respectively comprises a solid bottom wall 16a, 17a, 18a, 19a, having two returns, front and rear respectively, positioned perpendicularly on either side of said bottom wall 16a, 17a, 18a, 19a. The rear return includes a series of recesses 26 allowing the structure of the frame 2 to be lightened without challenging the expected elastic deformability of the frame 2. The attachment screws 22 respectively protrude at the front return of the side edges 18, 19.

As illustrated in FIG. 4, the complementary attachment sub-assembly 6 is attached on a stationary element 4, in this case the frame of the body of a motor vehicle, by means of a screw not shown. Of course, other methods for attaching the attachment sub-assembly 6 onto the stationary element 4 are within the reach of one skilled in the art.

When the guide 7 is inserted into the sliding section S, the means 11 to resist movement, in this case the lugs 11a, 11b are in contact with the first track 12, and this as illustrated in FIGS. 1 and 2. The whole of the fins, 8, 9, 23, 24 of the frame 2 are in the so-called [symbol] rest [symbol] position.

As the door 3 is gradually opened, the lugs 11a, 11b slide on the first track 12, until they pass over the lugs 10a, 10b. During this passing, the whole of the fins 8, 9, 23, 24 deform and this as this is in particular illustrated in FIGS. 5b and 6b. They are in the so-called [symbol] stress [symbol] position.

In order to accomplish this transition, the person proceeding with the opening of the door 3 has to exert additional forces in order to force the lugs 11a, 11b to cross this obstacle, in this case the lugs 10a, 10b, in order to come into contact with the second track 13 of the guide 7. The door 3 will then be stabilized in the open position, and the whole of the fins 8, 9, 23, 24 are no longer deformed. They have again found their so-called [symbol] rest [symbol] position.

The second track 13 of each rail 25a, 25b is closed in order to avoid extraction of the guide 7 of the frame 2.

Next, it is therefore necessary to exert forces in the opposite direction in order to force the lugs 11a, 11b to cross the obstacles 10a, 10b with view to their coming back into contact with the first track 12 so as to be able to close the door 3.

Of course, the spacing-apart device 1 may be mounted in an inverted way relatively to what has been described above, and this without challenging the general operation of the invention.

Although the invention has been described in connection with particular exemplary embodiments, it is quite obvious that it is by no means limited thereto and that it comprises all the technical equivalents of the described means, as well as their combinations if the latter enter the scope of the invention.

1. An attachment sub-assembly making up a spacing-apart device and intended to be attached on an opening element or on a stationary element, said attachment sub-assembly comprising at least one frame which includes:
at least one first side edge and at least one second side edge,
at least one first main fin and at least one second main fin,
said first main fin and second main fin each extending between the first side edge and the second side edge so as to delimit between them a sliding section,
said first main fin and second main fin being equipped with means to resist movement, intended to cooperate with complementary means to resist movement of a complementary attachment sub-assembly intended to be attached on the stationary element or the opening element, wherein said attachment sub-assembly is made in one piece.

2. The attachment sub-assembly according to claim 1, wherein said attachment sub-assembly is made in one piece in plastic material.

3. The attachment sub-assembly according to claim 1, wherein said first main fin and second main fin are substantially parallel.

4. The attachment sub-assembly according to claim 1, wherein the means to resist movement are made in the form of protruding abutment elements positioned facing each other on the first and second main fin, respectively.

5. The attachment sub-assembly according to claim 1, wherein at least two secondary fins extend between the first side edge and the second side edge of the frame and are respectively positioned on either side of the sliding section.

6. The attachment sub-assembly according to claim 5, wherein the first main fin is connected to the secondary fin which is adjacent to it through at least one first means acting as a structure reinforcement and in that the second main fin is connected to the secondary fin which is adjacent to it through at least one second means acting as a structure reinforcement.

7. The attachment sub-assembly according to claim 6, wherein the first and second means acting as a structure reinforcement are respectively positioned in the middle transverse plane of the first main fin and of the second main fin.

8. The attachment sub-assembly according to claim 5, wherein said first and second main fins and the secondary fins each have a substantially convex edge.

9. A device for spacing an opening element apart from a stationary element wherein it comprises:
at least one attachment sub-assembly according to claim 1,
at least one complementary attachment sub-assembly making up a spacing-apart device, and intended to be attached on a stationary element or on an opening element, said complementary attachment sub-assembly being extended with a guide, said guide comprising complementary means to resist movement, intended to cooperate with means to resist movement of the attachment sub-assembly, said guide being made as a plate having a first face and a second face each equipped with a contact area split up into a first track and into a second track extending on either side of the complementary means to resist movement.

10. The device for spacing an opening element apart from a stationary element according to claim 9, wherein the contact area of the first face and the contact area of the second face are respectively made in the form of a rail.

11. The device for spacing an opening element apart from a stationary element according to claim 9, wherein the second track of each rail is closed.

12. The device for spacing an opening element apart from a stationary element according to claim 9, wherein it is made in plastic material.
